(19) United States
(12) Patent Application Publication
(10) Pub. No.: US 2013/0100182 A1
(43) Pub. Date: Apr. 25, 2013

(54) COMPENSATION METHOD FOR PRIVACY-IMAGE PROTECTION

(71) Applicants: Chao-Wei YEH, Hsin-Chu (TW); Chih-Hsiang Yang, Hsin-Chu (TW); Chien-Huang Liao, Hsin-Chu (TW); Wen-Hao Hsu, Hsin-Chu (TW)

(72) Inventors: Chao-Wei YEH, Hsin-Chu (TW); Chih-Hsiang Yang, Hsin-Chu (TW); Chien-Huang Liao, Hsin-Chu (TW); Wen-Hao Hsu, Hsin-Chu (TW)

(73) Assignee: AU OPTRONICS CORP., Hsin-Chu (TW)

(21) Appl. No.: 13/471,594

(22) Filed: May 15, 2012

(30) Foreign Application Priority Data
Oct. 24, 2011 (TW) 100138589

(51) Int. Cl. G09G 5/02

(52) U.S. Cl. 345/694

(57) ABSTRACT

A compensation method for privacy-image protection is provided. The compensation method operates a display device in a narrow visual-angle mode, then determines where is data to be displayed according to a relative position between the data to be displayed and a specific object, and finally determines to use which to adjust the data to be displayed according to the determined result, and displays the data.

### FIELD

The present disclosure relates to a compensation method for privacy-image protection, and more particularly to a compensation method for privacy-image protection, which is able to reduce a data-shading effect caused by privacy images for normal users outside of normal visual angles.

### BACKGROUND

In generally, display devices generally have a display effect of wide visual-angle, so as to provide images to a plurality of viewers. However, at some moments or positions, for example, when reading confidential information or inputting passwords, the display effect of wide visual angle is easy to make the confidential information glanced by others, so as to divulge the confidential information. Therefore, in order to meet two different needs of providing images to the plurality of viewers and processing the confidential information in public, a display device with an adjustable visual angle which can be switched between a wide visual-angle mode and a narrow visual-angle mode, has gradually been a main trend of the display device market.

The conventional privacy-image protection mechanism of the display device, may be divided into following types: directly installing a sheet for privacy-image protection, using a backlight source controlling method, and adding a visual-angle controlling module unit, etc. However, the conventional privacy-image protection mechanism has many disadvantages, such as losing display quality, optical characters, thickness and weight thereof, when achieving the effect for privacy-image protection, and they may more or less limit the visual angle of the normal users.

Referring to FIG. 1, when the users views a display device 10, the users generally need to extend certain visual angles (e.g. the visual angle θ1 and the visual angle θ2) to the left and to the right respectively, so as to cover the whole display device 10. However, because the principle of the privacy-image protection mechanism causes the variation of the images when viewing laterally, thus the users are more or less disturbed by the privacy-image protection mechanism when laterally viewing the display device 10, and watch specific images on the screen of the display device caused by the various privacy-image protection mechanism, such as mosaic grid images, so as to influence reading or working. For example, in display regions C1 and C2 in which the visual angles are larger than 10 degrees, the users may feel to be disturbed by the various images caused by the privacy-image protection mechanism.

In order to improve the using quality of the display device, designers must not only provide the privacy-image protection function, but also make the users use freely.

### SUMMARY

The present disclosure relates to a compensation method for privacy-image protection, which can improve qualities of images viewed by a user when using a privacy-image protection mechanism.

The present disclosure also relates to a compensation method for privacy-image protection, which can reduce image interference caused by a privacy-image protection mechanism for a normal user.

The present disclosure provides a compensation method for privacy-image protection, which is adapted into a display device when displaying images. The display device comprises a plurality of sub pixels. When the display device operates in a narrow visual-angle mode, the luminous flux of at least one sub pixel thereof along the first visual-angle direction is different from that of another sub pixel along the first visual-angle direction. The compensation method comprises: operating the display device in the narrow visual-angle mode; determining a relative position between sub pixels to be driven and a specific object; and selecting a corresponding driving-voltage group to drive the sub pixels according to the relative position.

The present disclosure also provides a compensation method for privacy-image protection, which is adapted into a display device when displaying images. The luminous fluxes of at least two regions of the display device along a first visual-angle direction are different. The compensation method comprises: operating the display device in the narrow visual-angle mode; determining where is data be displayed, according to a relative position between the data to be displayed and a specific object; determining to use which of at least two modes to adjust the data to be displayed, according to the above determined result; and displaying the adjusted data.

Preferably, the luminous flux of at least one sub pixel thereof along the first visual-angle direction is different from that of the same sub pixel thereof along a second visual-angle direction opposite to the first visual-angle direction.

The present disclosure can adjust different display data for different visual angles, to appropriately change the luminous flux at the lateral position, such that the normal user is not influenced by the privacy-image protection mechanism at the later position when watching the images.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic view for visual angles and images of a display device influenced by a privacy-image protection mechanism.

FIG. 2 is a schematic view for showing distribution ratios of liquid crystals in various regions of a sub pixel of a display device, which uses a compensation method for privacy-image protection, in accordance with an exemplary embodiment of the present disclosure.

FIG. 3A is a schematic view for showing driving brightness of pixel regions when the display device operates in a wide visual-angle mode (WVM).

FIG. 3B is a schematic view for showing driving brightness of pixel regions when the display device operates in a narrow visual-angle mode (NVM).

FIG. 4 is a flow chart of a compensation method for privacy-image protection in accordance with an exemplary embodiment of the present disclosure.

FIG. 5 is a flow chart of the step S402 in FIG. 4 in accordance with an exemplary embodiment of the present disclosure.

FIG. 6A is a flow chart of the step S404 as shown in FIG. 4 in accordance with an exemplary embodiment of the present disclosure.

FIG. 6B is a flow chart of the step S404 as shown in FIG. 4 in accordance with another exemplary embodiment of the present disclosure.

FIG. 7A is a schematic view for showing a relationship curve of the brightness and the gray level generated in a visual-angle region, which is driven by two different driving modes, when laterally watching at a lateral angle with 10 degrees.

FIG. 7B is a schematic view for showing a relationship curve of the brightness and the gray level generated in a visual-angle region, which is driven by two different driving modes, when laterally watching at a lateral angle with 20 degrees.

FIG. 8 is a flow chart of a compensation method for privacy-image protection in accordance with another exemplary embodiment of the present disclosure.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

In order to describe the present disclosure conveniently, the following will employ optical characters of a LCD (liquid crystal display) panel as an example, to describe the present disclosure. However, it is known for persons skilled in the art that, the present disclosure may also be adapted into other materials which have a light-guiding character.

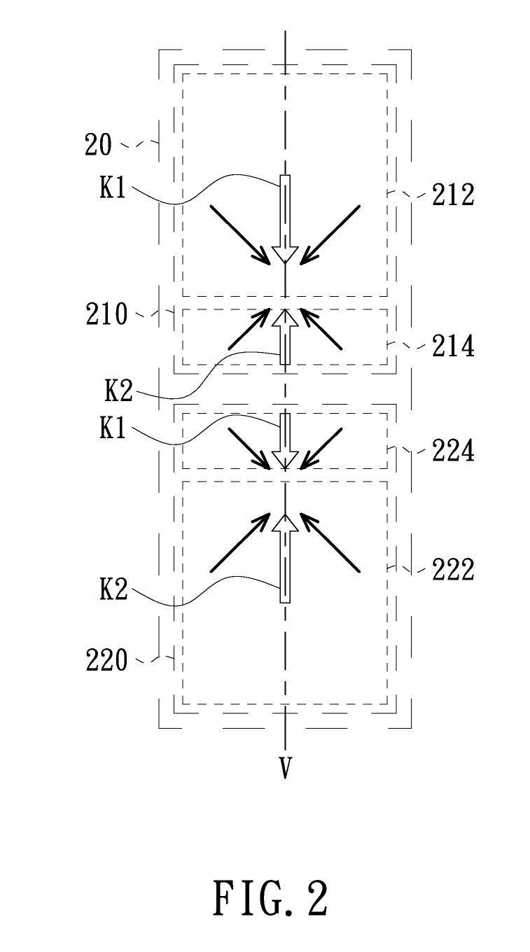

FIG. 2 is a schematic view for showing distribution ratios of liquid crystals in various regions of a sub pixel of a display device, which uses a compensation method for privacy-image protection, in accordance with an exemplary embodiment of the present disclosure. As shown in FIG. 2, a sub pixel 20 comprises a first region 210 and a second region 220, the first region 210 comprises a primary region 212 and an ancillary region 214, and the second region 220 comprises a primary region 222 and an ancillary region 214. Solid arrows represent inclining directions of liquid crystals, and hollow arrows K1 and K2 represent a vertically-downward visual-angle direction and a vertically-upward visual-angle direction respectively. Vectors of K1 and K2 are designed in a non-equivalent mode, which wishes a design of pixels with the vertical light transmission imbalance, to achieve a function for privacy-image protection.

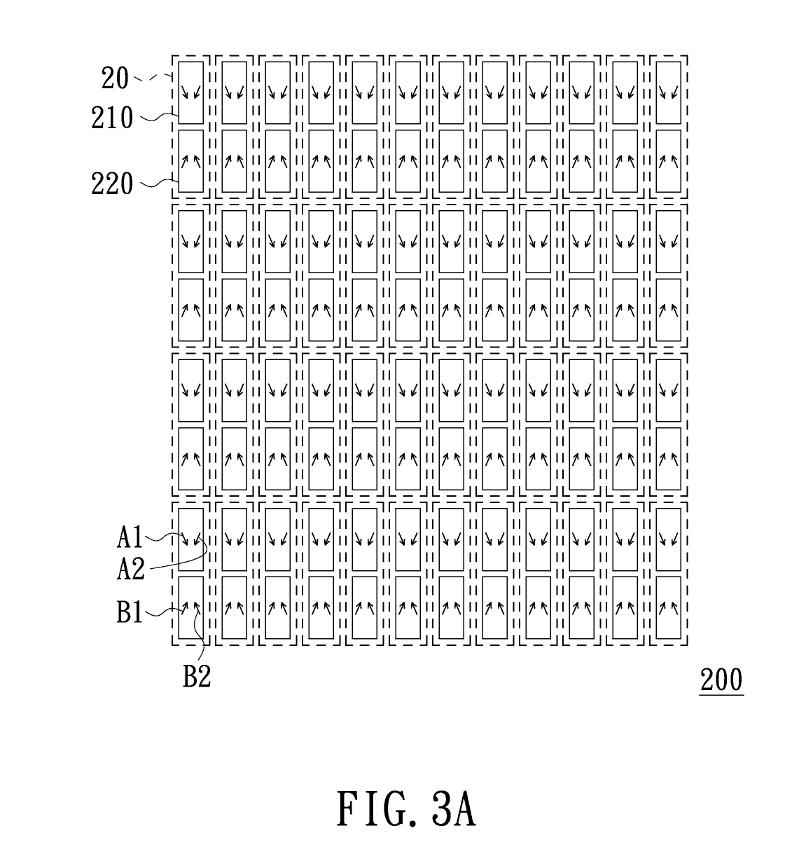

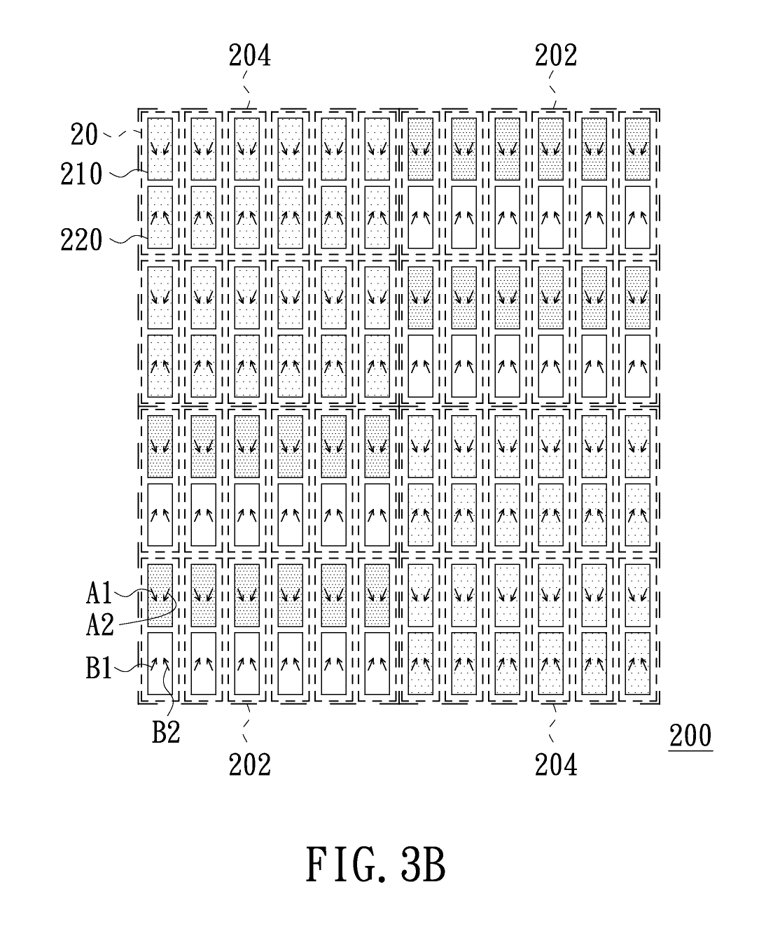

Refer to FIGS. 3A and 3B, which are schematic views for showing arranging structures of inner pixels of the display device, which uses the compensation method for privacy-image protection of the present disclosure. FIG. 3A is a schematic view for showing driving brightness of pixel regions when the display device operates in a wide visual-angle mode (WVM), and FIG. 3B is a schematic view for showing driving brightness of pixel regions when the display device operates in a narrow visual-angle mode (NVM).

In the exemplary embodiment as shown in FIGS. 3A and 3B, the display device 200 comprises a plurality of sub pixels 20 which are arranged in a matrix and as shown in FIG. 2. In the wide visual-angle mode as shown in FIG. 3A, first regions 210 and second regions 220 of all of the sub pixels 20 are normally lighted, to provide same brightness for each visual angle, so as to watch in the wide visual-angle mode. However, in the narrow visual-angle mode as shown in FIG. 3B, not all of the sub pixels 20 are lighted by a same mode. In the exemplary embodiment as shown in FIG. 3B, lighting modes of the sub pixels 20 are divided into two types: one is for a pixel region 202 and another is for a pixel region 204, for providing two different visual-angle brightness.

In the pixel region 202, the first region 210 of each of the sub pixels 20 will be closed (not lighted) or applied by a driving voltage substantially less than that of the second region 220, and the second region 220 is in a normal-lighted status. Because the liquid crystals with an alignment direction B1 (about 45 degrees) and the liquid crystals with an alignment direction B2 (about 135 degrees) in the second region 220 substantially occupy in a large proportion thereof, the whole optical character of the pixel region 202 will be mainly determined by the liquid crystals with the alignment direction B1 or the liquid crystals with the alignment direction B2. In contrast, the first region 210 and the second region 220 of each of the sub pixels 20 in the pixel region 204 are both in the normal-lighted status, thus, the proportion of the liquid crystals with an alignment direction A1 (about 315 degrees) and the liquid crystals with an alignment direction A2 (about 225 degrees) in the first region 210 is same to that of the liquid crystals with the alignment direction B1 and the liquid crystals with the alignment direction B2 in the second region 220. Therefore, it can provide same brightness for various visual angles at this moment, which is same to that as shown in FIG. 3A.

Referring to FIG. 3B, by various regular or irregular modes to arrange the pixel regions 202 and 204 driven by two different driving methods, the present disclosure can perform different designs for the brightness for visual angles, to employ the brightness difference of various visual angles, so as to achieve the effect for the privacy-image protection. Of course, ranges, arrangement modes and driving modes of the pixel regions 202 or 204 are not limited by the description as shown in FIG. 3B, which is known for persons skilled in the art, and it is not described herein.

In theory, it is a perfect design. However, the display panel is gradually expanding, thus a user may only squarely watch a part of the display panel, and laterally watch other parts of the display panel. After the experiment, when a lateral visual angle exceeds over a certain angle, images viewed by the user may start to be disturbed by the privacy-image protection mechanism, such that the images are difficult to be viewed freely. For example, in the display device with the function for privacy-image protection which uses the design of the pixels with the vertical light transmission imbalance, as shown in FIGS. 3A and 3B, it will be influenced by the privacy-image protection mechanism when the lateral visual angle reaches about 10 degrees. Moreover, in the display device with the function for privacy-image protection which uses the design of the pixels with the horizontal light transmission imbalance, it will be influenced by the privacy-image protection mechanism when only squarely watching the display device.

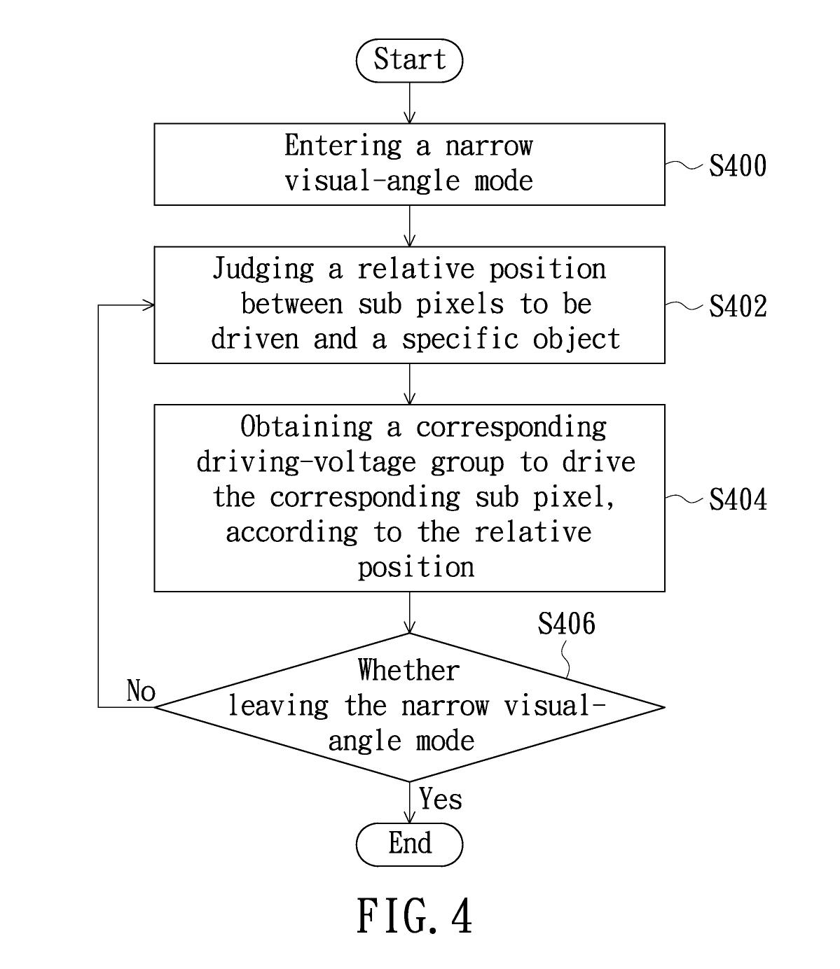

FIG. 4 is a flow chart of a compensation method for privacy-image protection in accordance with an exemplary embodiment of the present disclosure. In the exemplary embodiment, the compensation method comprises: firstly entering a narrow visual-angle mode (Step S400); then judging a relative position between a sub pixel to be driven (the sub pixel 20 as shown in FIG. 2A, 3A or 3B) and a specific object (Step S402); and selecting a corresponding driving-voltage group to drive corresponding sub pixels, that is, performing a driving operation for following sub pixels, according to the relative position (Step S404).

After finishing the above operations, the compensation method may further comprise: judging whether or not leaving the narrow visual-angle mode (Step S406). If the display device is still in the narrow visual-angle mode, the flow will return to the step S402 and perform the same operations. If the display device is switched to be in the wide visual-angle mode, the compensation method will leave the above flow. It should be noted that, the judgment in the step S406 is not limited to be performed once when obtaining the driving-voltage group every time. For example, the judgment in the step S406 may be performed once after completely displaying a frame image each time, or spaced by every predetermined period.

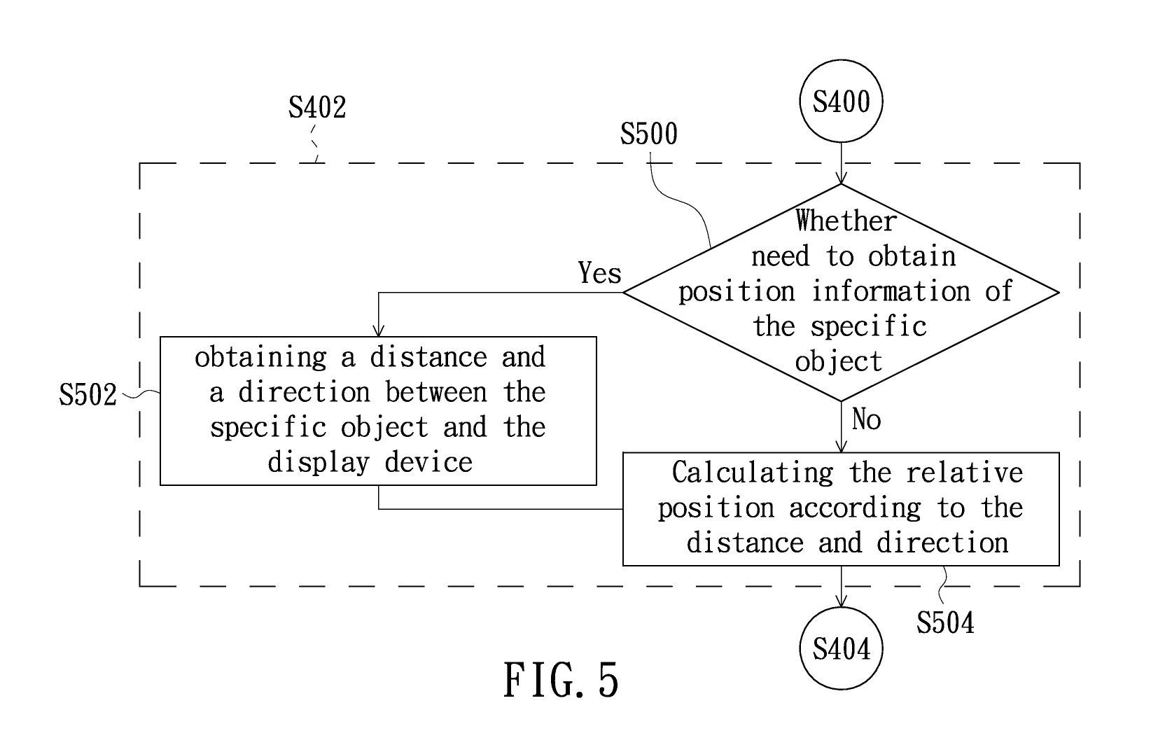

Next referring to FIG. 5, which is a flow chart of the step S402 in FIG. 4 in accordance with an exemplary embodiment of the present disclosure. In the exemplary embodiment, after the step S400 of entering the narrow visual-angle mode, it firstly judges whether or not need to obtain position information of specific object, such as a distance and a direction between the specific object and the display device (Step S500). If necessary, it enters Step S502 to obtain the relative position information. In contrast, if the judgment of the step S500 judges it does not need to obtain the position information, or after perform the step S502 to obtain the position information, the flow enters Step S504 to calculate the relative position between the sub pixel to be driven and the specific object according to the obtained distance and the obtained direction.

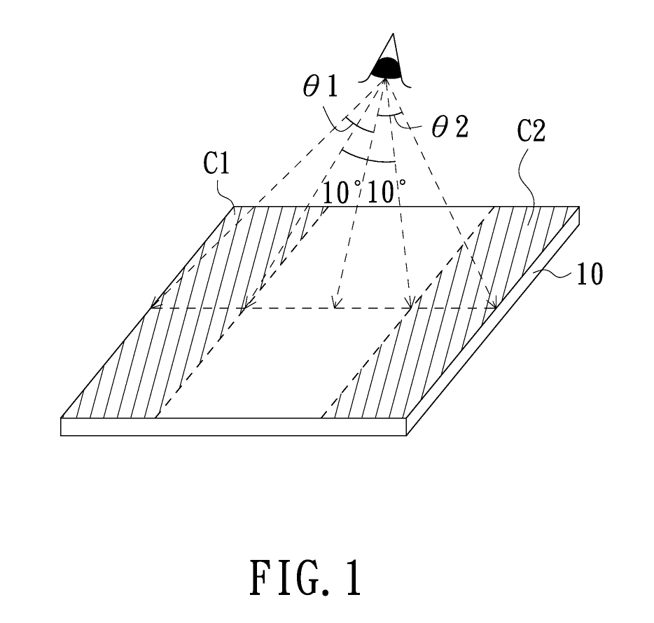

In generally, the relative position calculated in the step S504 is represented by an intersecting angle defined by a direction of the specific object (such as, eyes of the user) squarely watching the display device, and a line between the specific object and the sub pixel to be driven. That is, for example, in FIG. 1, if the sub pixel to be driven is located in the right edge of the display region C1, the relative position may be marked as −10 degrees (because of leaning to the left from squarely watching, a negative sign is added). In contrast, if the sub pixel to be driven is located in the left edge of the display region C2, the relative position may be marked as 10 degrees. The following will describe the present disclosure by the above intuitive marking method, however, the present disclosure may be described by other methods to represent the calculated relative position.

It should be noted that, although the exemplary embodiment judges whether or not need to obtain the position information of the specific object once when entering the step S402 every time, in fact, it may directly obtain the position information without judgment (that is, directly entering the step S502 from the step S400, without entering the step S500). Alternatively, it may perform the judgment operation of the step S500 once spaced by every predetermined period, such as, after displaying a frame image.

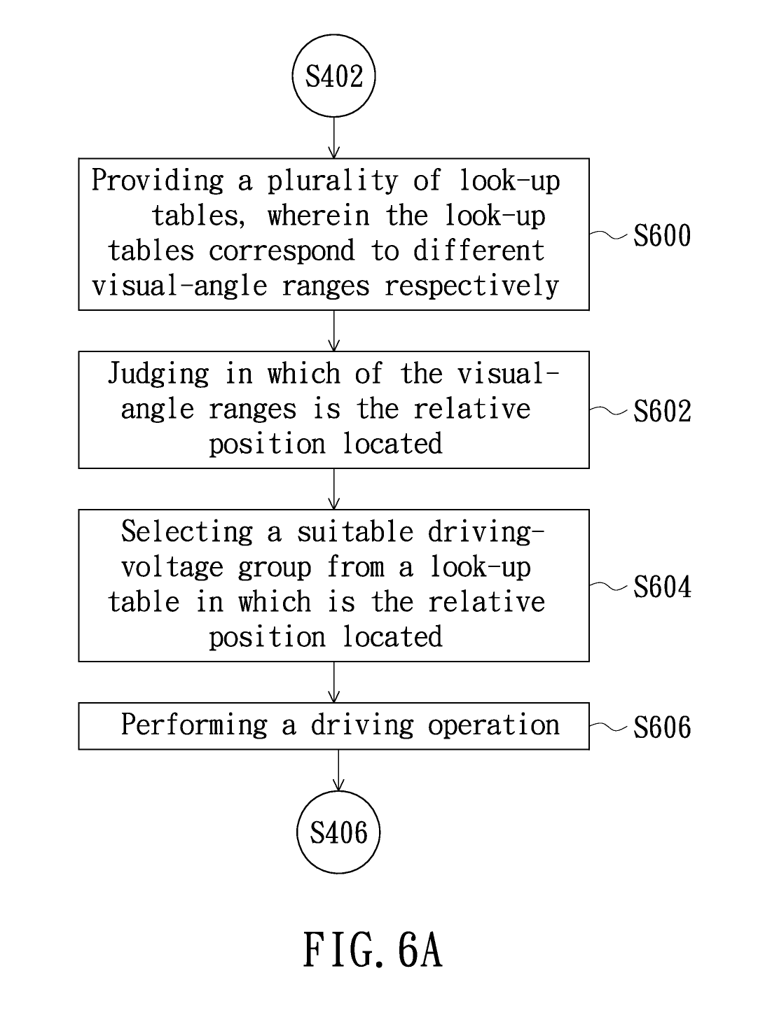

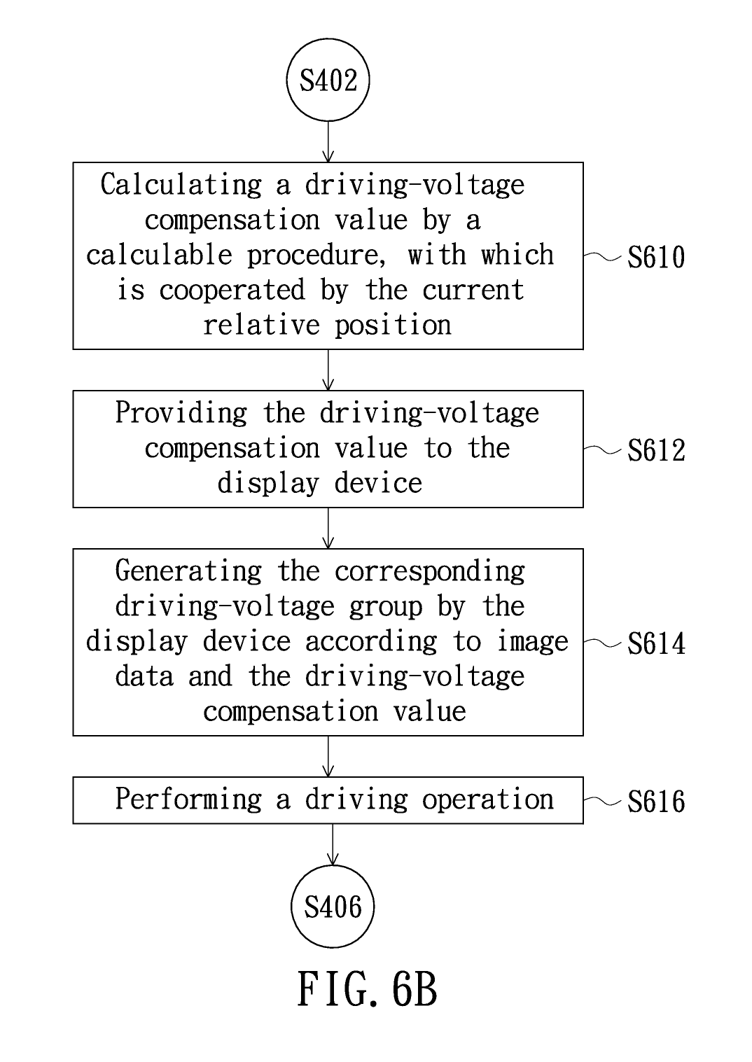

Next refer to FIG. 6A, which is a flow chart of the step S404 as shown in FIG. 4 in accordance with an exemplary embodiment of the present disclosure. In the exemplary embodiment, after the step S402, the flow will enter Step S600 to obtain a plurality of look-up tables which are pre-provided, and each of the look-up tables corresponds to a different visual-angle range respectively. The following will compare the relative position (which is a certain angle intuitively described in the above) obtained in the step S402 and the visual-angle ranges corresponding to the look-up tables, to judge which of the visual-angle ranges is the obtained relative position located in (Step S602). After obtaining the information of the relative position located in a certain specific visual-angle range, it will perform a data-reading operation for a look-up table corresponding to the certain visual-angle range, and obtain a driving-voltage group suited for image data to be displayed (Step S604), and finally use the driving-voltage group to perform a following driving operation (Step S606).

The advantage of using the look-up tables is that the look-up tabled may be built-in a time controller of the display device, such that it can achieve a fast processing speed, and does not additionally process pixel data of the system providing to the display device. Therefore, it can reduce the difficult of the compensation method for privacy-image protection being accepted.

Of course, except using the look-up tables, the present disclosure may further add a calculable procedure in an external system, to calculate according to some empirical data, or access a database to achieve the compensation effect for privacy-image protection. Refer to FIG. 6B, which is a flow chart of the step S404 as shown in FIG. 4 in accordance with another exemplary embodiment of the present disclosure. In the exemplary embodiment, after the step S402, the flow will enter Step S610 to find out the calculable procedure which is pre-provided, and using the calculable procedure to calculate a driving-voltage compensation value, wherein different driving-voltage compensation values correspond to different relative positions respectively. Next, the calculated driving-voltage compensation value is provided to the display device (Step S612), and the display device generates a driving-voltage group which is obtained by the compensation process and configured for driving corresponding sub pixels, according to the driving-voltage compensation value cooperating with original image data to be displayed (Step S614). Finally, the driving-voltage group is used to perform the following driving operation (Step S616).

Obviously, the exemplary embodiment as shown in FIG. 6B is installing a pre-designed calculable procedure in the system out of the display device, and using the obtained relative position as a parameter to calculate the needed driving-voltage compensation value, to provide the calculating result to the display device. This method can provide a flexible compensation mechanism, be convenient in updating or maintaining, and can effectively reduce required memory device of the display device, and have better competitiveness in the hardware cost.

It should be noted that, the exemplary embodiments as shown in FIGS. 6A and 6B may be operated in other different applications. For example, the look-up tables as shown in FIG. 6A may be stored in other places out of the display device, and the found corresponding driving-voltage group is provided directly to the display device. Alternatively, the calculable procedure as shown in FIG. 6B may be directly arranged in the display device. Of course, the two exemplary embodiments may be combining used, and related design can change according to actual needs and will not influence the design scope of the present disclosure.

In summary, various exemplary embodiments of the present disclosure employ different compensation modes for different visual angles, to reduce the influence of the privacy-image protection mechanism for the normal user. Therefore, when performing the compensation operation, the present disclosure mainly makes each point of the display device can generate an approximate optical performance for the specific object (such as, eyes of the user). That is, when displaying a same gray level, the present disclosure may make a whole large block have approximate brightness, contrast ratio, etc, rather than a large block is consisted of a plurality of small blocks which are largely different in the brightness, the contrast ratio, etc.

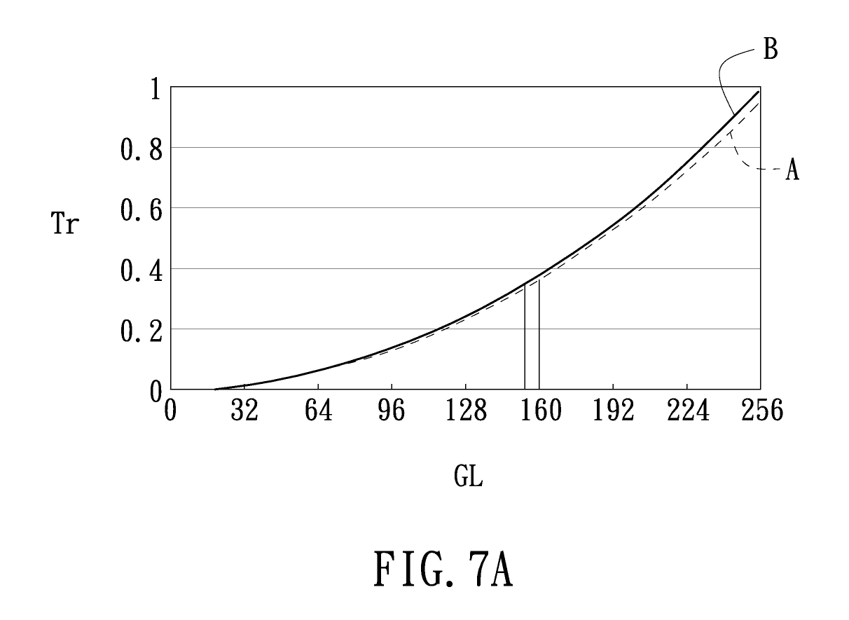

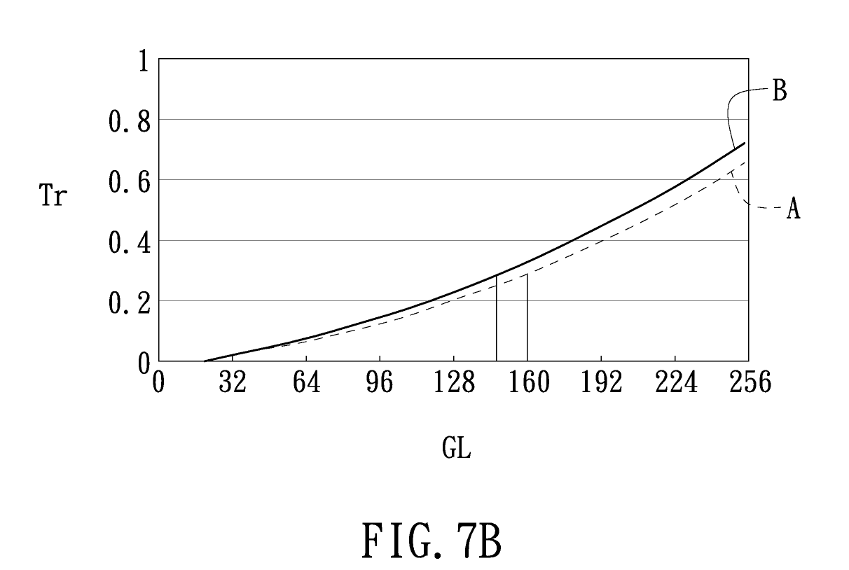

Therefore, if thinking over the influence of the above optical performance when performing the compensation operation, the present disclosure may achieve a better effect. Refer to FIGS. 7A and 7B, wherein FIG. 7A is a schematic view for showing a relationship curve of the brightness (the transmission ratio, Tr) and the gray level generated in a visual-angle region, which is driven by two different driving modes in a display device with the vertical light transmission imbalance, when laterally watching at a lateral angle with 10 degrees; and FIG. 7B is a schematic view for showing a relationship curve of the brightness and the gray level generated in a visual-angle region, which is driven by two different driving modes in a display device with the vertical light transmission imbalance, when laterally watching at a lateral angle with 20 degrees.

When displaying the image with a gray level of 160, in a condition of laterally watching at the lateral angle with 10 degrees, for the display region which is driven by the first driving mode (only opening a part of the visual-angle regions, as indicated by the curve marked by A), the display region is driven by a driving voltage same to that of the gray level of 160 when squarely watching. However, in the same condition, for the display region which is driven by the second driving mode (opening all of the visual-angle regions, as indicated by the curve marked by B), because it must be provided same lateral brightness, thus the curve A at the gray level of 160 in FIG. 7A must have the same lateral brightness. In other words, the display region should be driven by a driving voltage same to that of the gray level of 162 when squarely watching.

Similarly, when displaying the image with the gray level of 160, in a condition of laterally watching at the lateral angle with 20 degrees, for the display region which is driven by the first driving mode (only opening a part of the visual-angle regions, as indicated by the curve marked by A), the display region is driven by a driving voltage same to that of the gray level of 160 when squarely watching. However, in the same condition, for the display region which is driven by the second driving mode (opening all of the visual-angle regions, as indicated by the curve marked by B), because it must be provided same lateral brightness, thus the curve A at the gray level of 160 in FIG. 7B must have the same lateral brightness. In other words, the display region should be driven by a driving voltage same to that of the gray level of 146 when squarely watching.

Of course, another method is using the second driving mode as the standard, to adjust the driving voltage used in the first driving mode. However, it will generate a problem, that is, the two driving modes cannot obtain the same lateral brightness in the condition of high gray levels since the first driving mode is partly driven and the maximum brightness of the first driving mode is less than that of the second driving mode (which is completely driven). Therefore, the present disclosure is preferably using the first driving mode as the standard, to adjust the driving voltage used in the second driving mode. If using the second driving mode as the standard, it should cooperate with other adjusting strategies to achieve a better compensation effect.

The compensation method for privacy-image protection disclosed in the above exemplary embodiments will try to find out the relative position between the specific object and the visual-angle region to be driven. In other words, the above exemplary embodiments may cooperate with a head-tracking system or a eye-tracking system, to real-timely detect the position of the user for performing the dynamic compensation adjusting operation, so as to achieve a best compensation effect.

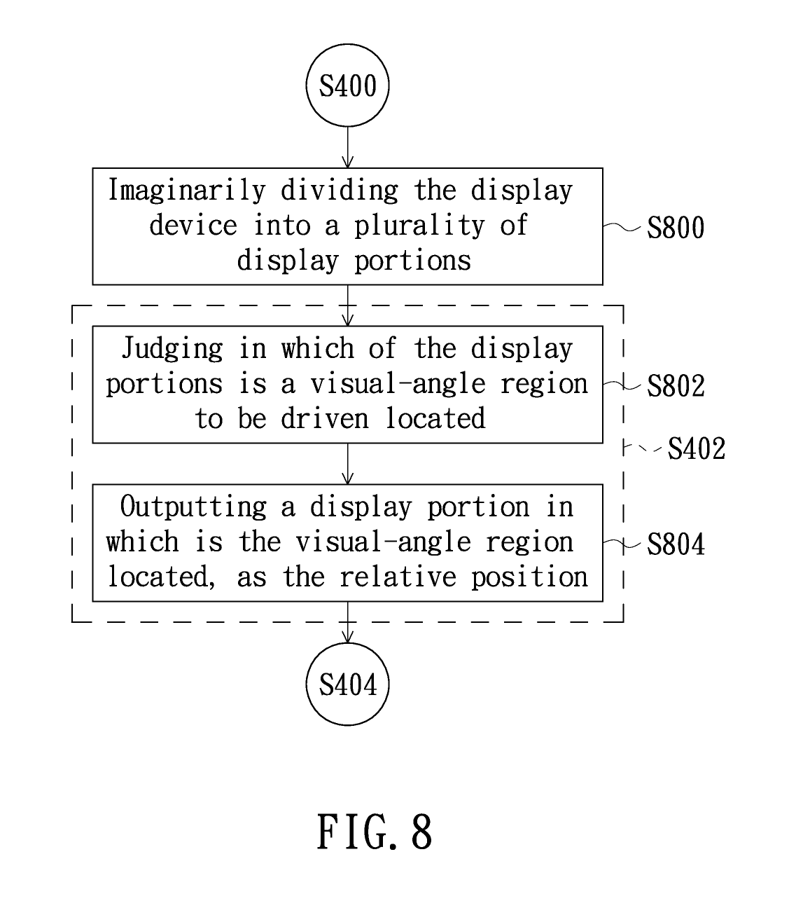

Refer to FIG. 8, which is a flow chart of a compensation method for privacy-image protection in accordance with another exemplary embodiment of the present disclosure. In the exemplary embodiment, the displayed image of the display device is imaginarily divided into at least two display portions, such as two shaded portions and one blank portion between the two shaded portions as shown in FIG. 1 (Step S800). Next, the compensation method may directly judge in which of the display portions is the visual-angle region located (Step 802), and directly output the judged display portion as the relative position mentioned in the step S402 (Step S804). The steps S802 and S804 may be considered as another embodiment of the step S402.

It should be noted that, when the exemplary embodiment is used in the display device which uses the horizontal light transmission imbalance to achieve the function for privacy-image protection, or the left edge or the right edge, the primary region and the ancillary region for each visual angle have different brightness. Therefore, for the lateral visual angle with −10 degrees (watching to the left) and the lateral visual angle with 10 degrees (watching to the right), although the absolute values of the two above lateral visual angles are same, they may need different driving-voltage groups to complete the driving operation. For example, in a visual-angle region on the left edge, if the driving voltage of the primary visual-angle region thereof is larger than the driving voltage of the ancillary visual-angle region thereof to compensate the luminous flux scattering to the right, for a visual-angle region on the right edge, it should be inverted to make the driving voltage of the primary visual-angle region thereof less than the driving voltage of the ancillary visual-angle region thereof to compensate the luminous flux scattering to the left. In contrast, if the same dividing mode is used in the display device which uses the vertical light transmission imbalance to achieve the function for privacy-image protection, the condition is relatively simple since the variations of the luminous fluxes on the left edge and on the right edge are same. However, if the dividing mode is altered from the vertically-divided blocks as shown in FIG. 1 to the horizontally-divided blocks, the method using the vertical light transmission imbalance needs a more complex computing, and the method using the horizontal light transmission imbalance is relatively signal. The detailed reason is similar with the above description, and it is not described herein.

It should be noted that, the display device which uses the horizontal light transmission imbalance to achieve the function for privacy-image protection, may be obtained by providing a pixel structure in which the region for providing the luminous flux to the right visual-angle direction in horizontal is different from the region for providing the luminous flux to the left visual-angle direction in horizontal, and cooperating with the pixel-arranging mode as shown in FIGS. 3A and 3B. However, the present disclosure is not limited herein.

In the exemplary embodiment as shown in FIG. 8, the specific object may be considered to not move relative to the display device. That is, the distance and the direction between the specific object and the display device keep forever unchanging. Therefore, the present disclosure may simply divide the display device into several display portions, and perform corresponding processes for the display portions respectively. This also may be used in the exemplary embodiment as shown in FIGS. 6A and 6B, but it is simpler. It may directly cooperate each of the display portions with a corresponding specific look-up table, or directly correspond each of the display portions to a specific calculating formula, and does not need the distance and the direction between the specific object and the display device to calculate the relative position between the visual-angle region to be driven and the specific object.

In summary, the methods of the above exemplary embodiments firstly operate the display device in the narrow visual-angle mode, then determine where is the date to be displayed located according to the relative position between the display position of the date to be displayed and the specific object, and finally selecting one of the at least two modes to adjust the date to be driven and performing the displaying operation according to the judged result.

Furthermore, the above exemplary embodiments may further be used in other display device except of the display device as shown in FIGS. 3A and 3B. In other words, any privacy-image protection mechanism which is caused by a pixel having different luminous fluxes at two opposite visual-angle directions in the narrow visual-angle mode, or any privacy-image protection mechanism which is caused by at least two display portions of the display device having different luminous fluxes at a same visual-angle direction in the narrow visual-angle mode, or any privacy-image protection mechanism which is caused by at least one display portion having different luminous fluxes at two opposite visual-angle directions, may use the methods of the above exemplary embodiments to compensate privacy images.

In summary, since the present disclosure can adjust different display data for different visual angles, the present disclosure can appropriately change the luminous flux at the lateral position, such that the normal user is not influenced by the privacy-image protection mechanism at the lateral position when watching the images.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A compensation method for privacy-image protection, adapted into a display device when displaying images, the display device comprising a plurality of sub pixels, wherein when the display device operates in a narrow visual-angle mode, the luminous flux of at least one sub pixel thereof along a first visual-angle direction is different from that of another sub pixel thereof along the first visual-angle direction, the compensation method comprising:
operating the display device in the narrow visual-angle mode;
determining a relative position between sub pixels to be driven and a specific object; and
selecting a corresponding driving-voltage group to drive the sub pixels according to the relative position.

2. According to claim 1, wherein the luminous flux of at least one sub pixel thereof along a first visual-angle direction is different from that of the same sub pixel thereof along a second visual-angle direction opposite to the first visual-angle direction.

3. The compensation method according to claim 1, wherein the step of judging the relative position between the sub pixels to be driven and the specific object, comprises:
periodically obtaining a distance and a direction between the specific object and the display device; and
calculating the relative position according to the obtained distance and the obtained direction.

4. The compensation method according to claim 3, wherein the step of selecting the corresponding driving-voltage to perform the following driving operation for the sub pixels to be driven according to the relative position, comprises:
providing a plurality of look-up tables, wherein the look-up tables correspond to different visual-angle ranges respectively;
judging in which of the visual-angle ranges is the relative position located;
obtaining the corresponding driving-voltage group from a look-up table corresponding to a visual-angle range in which is the relative position located; and
using the obtained driving-voltage group to perform the following driving operation.

5. The compensation method according to claim 3, wherein the step of selecting the corresponding driving-voltage group to perform the following driving operation for the sub pixels to be driven according to the relative position, comprises:
providing a calculable procedure to calculate a driving-voltage compensation value with which should be cooperated by the relative position;
providing the calculated driving-voltage compensation value to the display device; and
obtaining the driving-voltage group and performing the following driving operation by the display device according to the driving-voltage compensation value.

6. The compensation method according to claim 1, wherein the distance and the direction between the specific object and the display device are unchanged.

7. The compensation method according to claim 1, further comprising:
imaginarily dividing the display device into a plurality of display portions.

8. The compensation method according to claim 7, wherein the step of judging the relative position between the sub pixels to be driven and the specific object, comprises:
judging in which of the display portions is the sub pixels to be driven located; and
regarding a display portion in which the sub pixels are located, as the relative position.

9. The compensation method according to claim 8, wherein the step of selecting the corresponding driving-voltage group to perform the following driving operation for the sub pixels to be driven according to the relative position, comprises:
providing a plurality of look-up tables, each of the display portions corresponding to a corresponding one of the look-up tables;
obtaining the corresponding driving-voltage group from a look-up table corresponding to the display portion which is regarded as the relative position; and
using the obtained driving-voltage group to perform the following driving operation.

10. The compensation method according to claim 8, wherein the step of selecting the corresponding driving-voltage group to perform the following driving operation for the sub pixels to be driven according to the relative position, comprises:
providing a calculable procedure to calculate a driving-voltage compensation value with which should be cooperated by the relative position;
providing the calculated driving-voltage compensation value to the display device; and
obtaining the driving-voltage group and performing the following driving operation by the display device according to the driving-voltage compensation value.

11. A compensation method for privacy-image protection, adapted into a display device, wherein when the display device operates in a narrow visual-angle mode, luminous fluxes of at least two regions of the display device along a first visual-angle direction are different, the compensation method comprising:
operating the display device in the narrow visual-angle mode;
determining where is data to be displayed, according to a relative position between the data to be displayed and a specific object;
determining to use which of at least two modes to adjust the data to be displayed, according to the above determined result; and
displaying the adjusted data.

12. According to claim 11, wherein the luminous fluxes of a same region along the first visual-angle direction and a second visual-angle direction opposite to the first visual-angle direction are different.

13. The compensation method according to claim 11, wherein when the display device operates in the narrow visual-angle mode, the display device uses a mode of vertical light transmission imbalance or a mode of horizontal light transmission imbalance, to operate the display device in the narrow visual-angle mode.

14. The compensation method according to claim 13, wherein the vertical light transmission imbalance is caused by a region with luminous flux in a vertically-upward visual-angle direction different from another region with luminous flux in a vertically-downward visual-angle direction, or the horizontal light transmission imbalance is caused by a region with luminous flux in a horizontally-rightward visual-angle direction different from another region with luminous flux in a horizontally-leftward visual-angle direction.
